(19) United States
(12) Patent Application Publication
(10) Pub. No.: US 2014/0061410 A1
(43) Pub. Date: Mar. 6, 2014

(54) Model and Method for Attaching an Object to a Railing

(71) Applicant: Charbel Nassif, Sainte Eustache (CA)

(72) Inventor: Charbel Nassif, Sainte Eustache (CA)

(21) Appl. No.: 13/604,616

(22) Filed: Sep. 5, 2012

(51) Int. Cl. F16M 13/02

(52) U.S. Cl. CPC F16M 13/02
USPC 248/219.4

(57) ABSTRACT

A model and method for attaching an object to a railing is provided that serves to attach securely to a universal array of slats and spindles without causing damage thereto. The model and method has a clamp that is configured for attaching to the slats or spindles of a railing with jam plates that are covered by a non-abrasive material. A lightweight yet strong tubular body protrudes from the top of the clamp, and a strategically angled, lightweight and strong rod protrudes from the top of the tower. It is from the free end of the strategically angled rod that an object may be hung.

### FIELD OF THE INVENTION

The present invention relates to a model and method of attaching an item to the slats or spindles located on the side of a balustrade. More particularly, in its preferred use, the present invention relates to a model and method of attaching a decorative mobile to the slats or spindles of an child's crib.

### BACKGROUND OF THE INVENTION

Parents and caregivers naturally desire to provide a supportive and engaging environment in which their children can grow and flourish. The desire to provide a supportive and engaging environment begins prior to or at the birth of the child. For example, in preparing their home for the arrival of a child, parents and caregivers purchase and collect items that allow the child to eat, sleep, bathe, and play. An integral part of providing a supportive and engaging environment is introducing children to the vivid and beautiful colors and sounds of life.

In preparing their home for a child, most parents set up a crib in which to lay their child to sleep. Some of the time, the crib may be located in a nursery—a room or area in the home specifically designated as the place where the child sleeps and where his or her things are kept. The nursery is often decorated with the child's taste in mind, with bright colors and musical toys. In order to make the crib more conducive to stimulating the child's eyes and ears, many parents opt to attach a musical, colorful mobile to the child's crib.

The devices that serve to attach items to the slats or spindles on the sides of cribs that exist in the industry attach to the slats or spindles by coming into contact somehow with the top of the railing. These devices are comprised of a ledge of some sort that attaches to the top of the railing. This limits the area on the slats or spindles upon which a parent or caregiver can attach the device. For example, a parent or caregiver may not be able to attach the device in the corner of the crib or other desired spot because of the length of the ledge.

Further, the devices that exist in the industry are made of a hard plastic, metal, or other material that, when attached to the railing or slats of a child's crib, cause unsightly scratches, cuts and other damage to the surface of the crib. If the crib mobile's device for attachment somehow damages the surface of the railing or slats by scratching or cutting into them, it can take away from the beauty and the value of the crib itself.

Moreover, it is often the case that the attachment devices that exist in the industry are not made to attach to a universal array of railing and slat sizes on cribs. This causes various problems with the integrity of the attachment of the item to the crib. These problems include, but are not limited to, the crib mobile's attaching incorrectly or damaging the surface of the crib's railing or slats. If the crib mobile attaches crookedly or insecurely, it is potentially dangerous, as it could fall into the crib where the baby is lying. If the crib mobile falls into the crib, it can potentially injure the child.

As noted above, the devices that exist in the industry are limited in terms of the models of cribs to which they are able to attach. The devices are not made in such a way that they can attach to a universal array of cribs, regardless of the length and thickness of the railing or slats. For example, there are types of cribs that are especially bulky with thick rails and slats upon which such models cannot properly fit, thereby exacerbating the problem of an insecure or crooked attachment, or the problem of the crib mobile's scratching the surface of the crib.

Hence, in light of the aforementioned, there is a need for an improved device which, by virtue of its design and components, would be able to overcome or at least minimize some of the aforementioned problems with prior art. The industry needs a model and method by which a crib mobile can attach to the side of any crib securely and without causing damage to the surface of the crib.

### SUMMARY OF THE INVENTION

The object of the present invention is to provide a model and method of attaching an item to the slats of a railing in which the item attaches securely to a universal array of slats or spindles, without damaging the surface of the railing or its slats or spindles. By virtue of its design and components, this model and method satisfies the above-mentioned needs and is thus an improvement over other related devices and/or methods known in the prior art.

In accordance with the present invention, the above object, and other objects and advantages are achieved, as will be easily understood, with a model and method of attaching an item to the slats or spindles of a railing. The model and method meets the object by (1) attaching to the slats or spindles of the railing securely, without coming into contact with the top of the railing, and (2) attaching in such a way that whatever material comes into physical contact with the slats or spindles is coated with a special non-abrasive, non-skid, and non-slip material to prevent scratching or scuffing the surface of the crib. This is described briefly herein and is exemplified in the accompanying drawings.

More specifically, the above object is achieved with a model and method for attaching an item to a crib, the model comprising:

a clamp configured for attaching to the slats or spindles of a railing by a shaft that passes in between the slats or spindles of a railing,

a jam plate covered by a rubber or other non-abrasive, non-slip, non-skid material;

a nut-and-bolt system running via a central hole through the shaft of the clamp that tightens and loosens the clamp from the slats or spindles;

a tower of varying possible dimensions and weight protruding from the top of the clamp;

a strategically angled rod protruding from the top of the tower from which a colorful, musical children's mobile or other item may be hung.

Preferably, the shape and size of the clamp mechanism corresponds to the average shape and size of the slats of cribs on the market, although the clamp does not have to be of a particular shape and size in order to fit a universal array of slats on any railing. The clamp can be comprised of a number of dimensions and shapes.

Preferably, the clamp mechanism and all its components are constructed from a strong and lightweight material, perhaps plastic but not necessarily so. Furthermore, the jam plates that are comprised within the clamp mechanism are covered with a non-abrasive, non-slip, non-skid material, perhaps rubber but not necessarily so. This material preferably allows for maximum hold and support while preventing any damage, such as scratching or cutting, to the surface of the slats to which the clamp is secured.

Preferably, the size and shape of the central hole through the shaft of the clamp through which the nut-and-bolt system passes is such that it is sufficient to allow a parent or caregiver to tighten or loosen the nut from the bolt as necessary. The central hole and its corresponding nut-and-bolt system can therefore be of varying size and shape in order to serve this function.

Preferably, the material out of which the central hole and its corresponding nut-and-bolt system are made is a lightweight and strong material, such as a plastic, but it is not necessarily so.

According to yet another aspect of the present invention, there is also provided a crib with railings and slats with the above-mentioned clamping device.

According to yet another aspect of the present invention, there is also provided a kit with components for assembling the above-mentioned clamping device.

According to yet another aspect of the present invention, there is also provided a set of components for interchanging with the components of the above-mentioned kit.

According to yet another aspect of the present invention, there is also provided a method for assembling components of the above-mentioned clamping device, kit, crib with railings and slats, and/or set.

According to yet another aspect of the present invention, there is also provided a method of doing business with the above-mentioned clamping device, kit, crib with railings and slats, and/or set.

The objects, advantages, and other features of the present invention will become more apparent upon the reading of the following non-restrictive description of preferred embodiments thereof, given for purposes of exemplification only, with reference to the accompanying drawings.

### BRIEF DESCRIPTION OF THE DRAWINGS

FIG. 1 is a perspective of the model and method of attachment, according to a preferred embodiment of the present invention.

FIG. 2 is a larger perspective view of the lower portion of the model that is shown in FIG. 1.

FIG. 3 is a side perspective view of what is shown in FIG. 2.

FIG. 4 is a side perspective view of what is shown in FIG. 1.

FIG. 5 is a closer perspective of a portion of the model as shown in FIG. 4.

### DETAILED DESCRIPTION OF PREFERRED EMBODIMENTS OF THE INVENTION

In the following description, the same numerical references refer to similar elements. Furthermore, for sake of simplicity and clarity, namely so as not to burden unduly the figures with several reference numbers, only some of the figures have been provided with reference numbers, and components and features of the present invention illustrated in other figures can be easily inferred therefrom. The embodiments, geometrical configurations, materials mentioned and/or dimensions shown in the figures are preferred for exemplification purposes only.

Moreover, although the present invention was primarily designed for a child's crib, or for use with a colorful and musical mobile, it is understood that it may be used to attach other items or objects to slats or spindles that are not a part of a child's crib, but rather a different railing, as apparent to a person skilled in the art. For this reason, expressions such as “child,” “crib,” “musical,” “colorful,” etc., as used herein should not be taken as to limit the scope of the present invention and includes all other kinds of items, objects, and/or purposes with which the present invention could be used and may be useful.

Moreover, in the context of the present invention, the expressions “infant” and “child” can be used interchangeably.

Moreover, in the context of the present invention, the expressions “slat” and “spindle” can be used interchangeably.

Moreover, in the context of the present invention, the expressions “parent” and “caregiver” can be used interchangeably.

Moreover, in the context of the present invention, the expressions “jam plate” and “fixing pad” can be used interchangeably.

Moreover, in the context of the present invention, the expressions “nut” and “clamp nut” can be used interchangeably.

Moreover, in the context of the present invention, the expressions “mechanism,” “device,” “invention,” and “model” can be used interchangeably.

Moreover, in the context of the present invention, the expressions “angled” and “curved” can be used interchangeably.

Moreover, in the context of the present invention, the expressions “tower” and “tubular body” can be used interchangeably.

In addition, although the preferred embodiment of the present invention as illustrated in the accompanying drawings comprises various components and although the preferred embodiment of the support as shown consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the device, and corresponding parts, according to the present invention, as briefly explained and as can be easily inferred herefrom by a person skilled in the art, without departing from the scope of the invention.

### LIST OF NUMERICAL REFERENCES FOR SOME OF THE CORRESPONDING PREFERRED COMPONENTS ILLUSTRATED IN THE ACCOMPANYING DRAWINGS

10. Model (or “device”)

20. Front side of jam plate (or “fixing pad”)

20a. Back side of jam plate (or “fixing pad”)

22. Central threaded hole (or “hole”)

21. Thick, rubber or other non-abrasive, non-slip material

60. Bolt's nut (or “nut”)

50. Curved rod (or “rod”)

90. Ballustrade (or “railing” or “crib”)

Broadly described, the method and model for attaching an item to the slats or spindles of a railing according to the present invention and as shown in the accompanying drawings, is a device which, in its preferred intended use, allows for a secure and non-abrasive way to attach an item to the slats or spindles of a child's crib such that the child's eyes and ears can be stimulated by a colorful, musical mobile.

In a typical use of the device, the parent or caregiver will position the clamp mechanism on either side of the slats or spindles of the crib to which the parent or caregiver desires to attach the clamp. The parent or caregiver then tightens the clamp against the slats or spindles by twisting the nut-and-bolt system that runs through the shaft of the clamp, in between the slats or spindles. This secures the clamp to the slats or spindles. Then, the parent or caregiver will place a children's mobile to the outermost protruding end of the angled rod, such that it hangs over the child while the child is in the crib.

The clamp mechanism is constructed such that the material that comes into contact with the slats or spindles is covered in a rubber or other non-abrasive, non-slip, and non-skid material that allows for a secure attachment but prevents any scratching or other damage to the slats of the crib. The clamp does not have a component that comes into contact with the top of the railing, further preventing any damage to the surface of the crib.

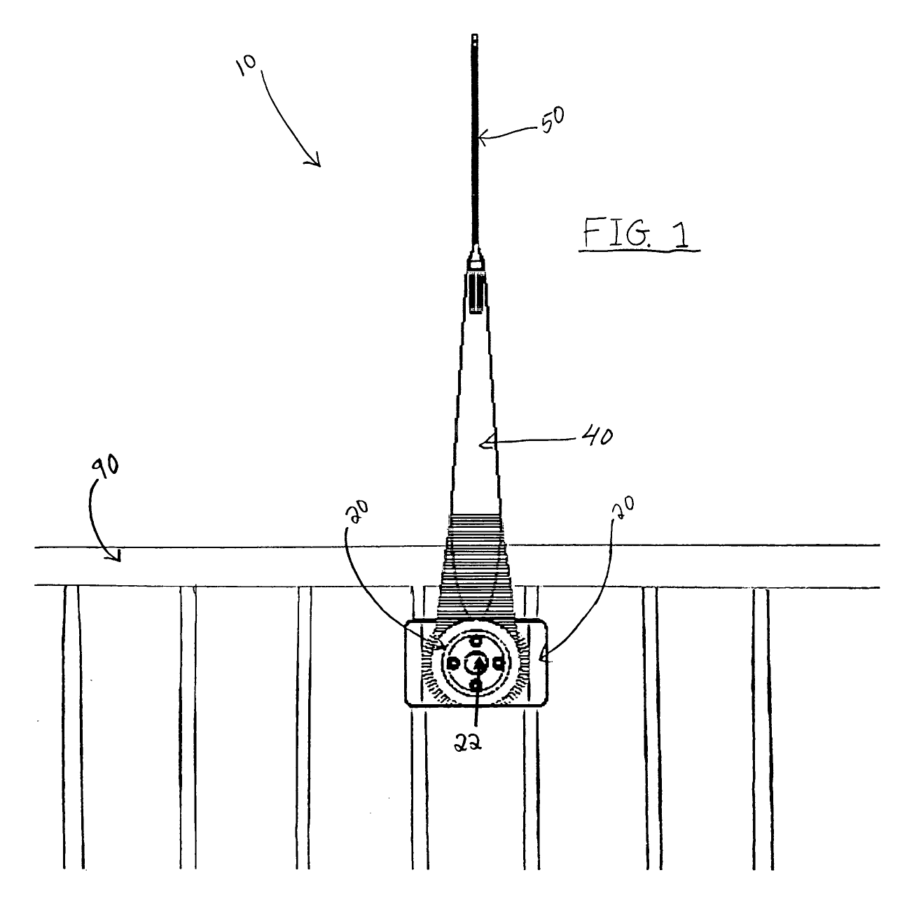

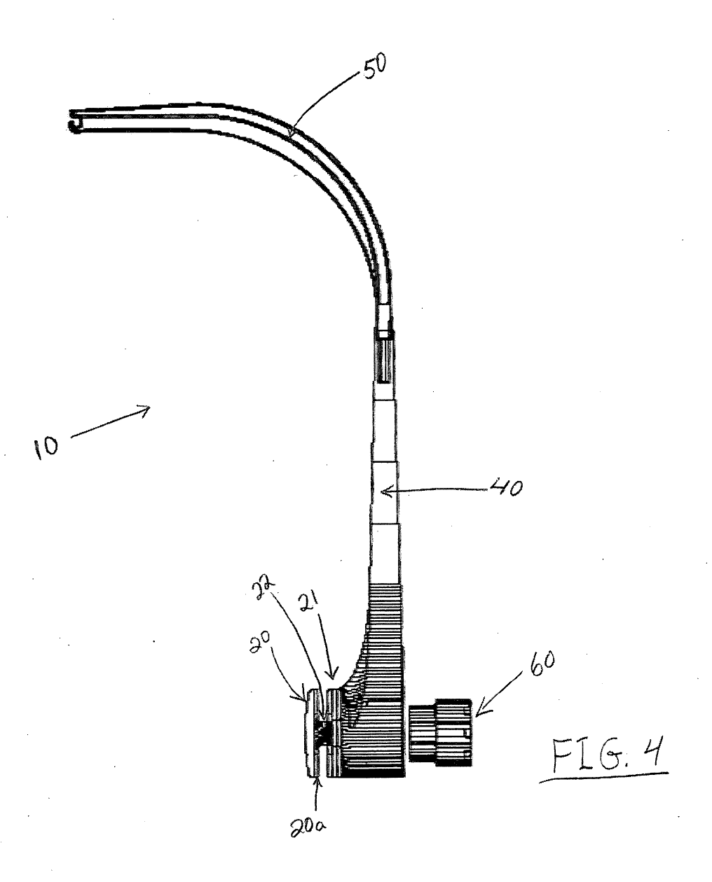

More specifically, and in reference to FIG. 1 and FIG. 4, the above uses are accomplished by a clamp mechanism comprised of parts 20, 20a, 22, 21, and 60. Parts 20a and 21 are constructed such that their surfaces come into contact with the slats spindles of any crib or railing, and not the top of the railing. This is achieved because the shaft of the clamp passes in between the slates or spindles. There is no part of the clamp that functions as a ledge that hangs or sits atop the railing. Rather, no part of the clamp mechanism touches the top of the railing. This serves to preserve the condition of the crib by preventing scratches or cuts to the top of the railing that would otherwise be caused by such a ledge.

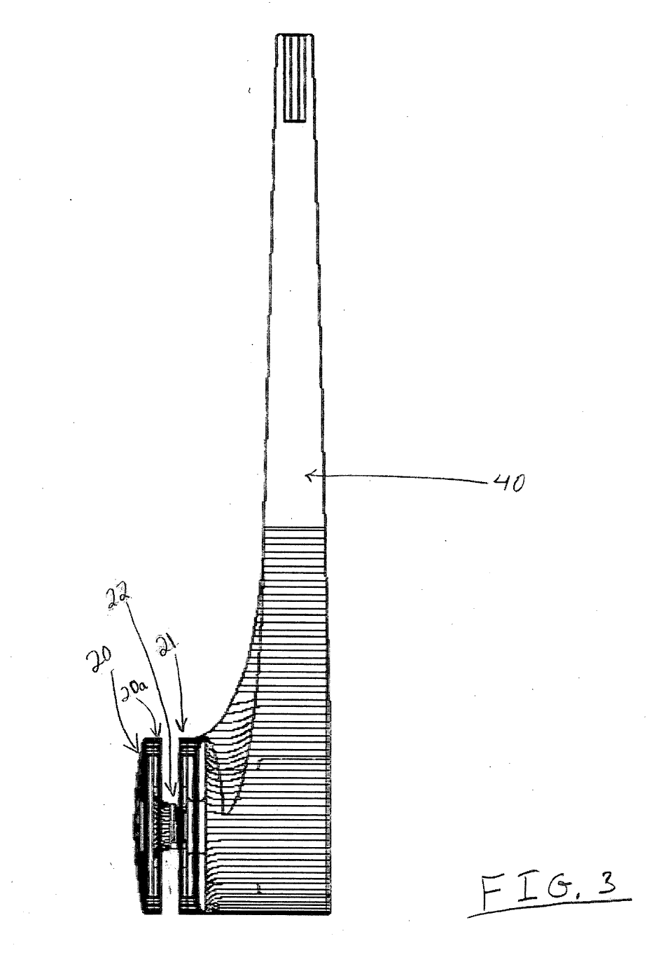

Further, and in reference to FIG. 3, the surfaces of parts 20a and 21 are covered by a rubber or other non-abrasive, non-slip, non-skid material so as to avoid any scratches or other damage to the surface of the slats, while maintaining a strong and stable method of attachment. This also serves to preserve the condition of the crib to which the clamp mechanism is attached by preventing scratches or cuts to the surface of the crib.

Further, and in reference to FIG. 1, the clamp attaches to the slats of a crib by a nut-and-bolt system that runs in between the slats or spindles. This nut-and-bolt system tightens the clamp such that the clamp is secured onto the side of the crib.

More specifically, and in reference to FIG. 1 and FIG. 4, the main bolt is built in to part 20, through a central threaded hole that runs through parts 20a, 21, 22, and 60. In part 22, the central threaded hole runs through a central washer with cores of three sizes supporting the main bolt, the smaller nut, and the larger nut, as illustrated in FIG. 4. The main bolt is secured on the back of the clamp by part 60, the main bolt's nut.

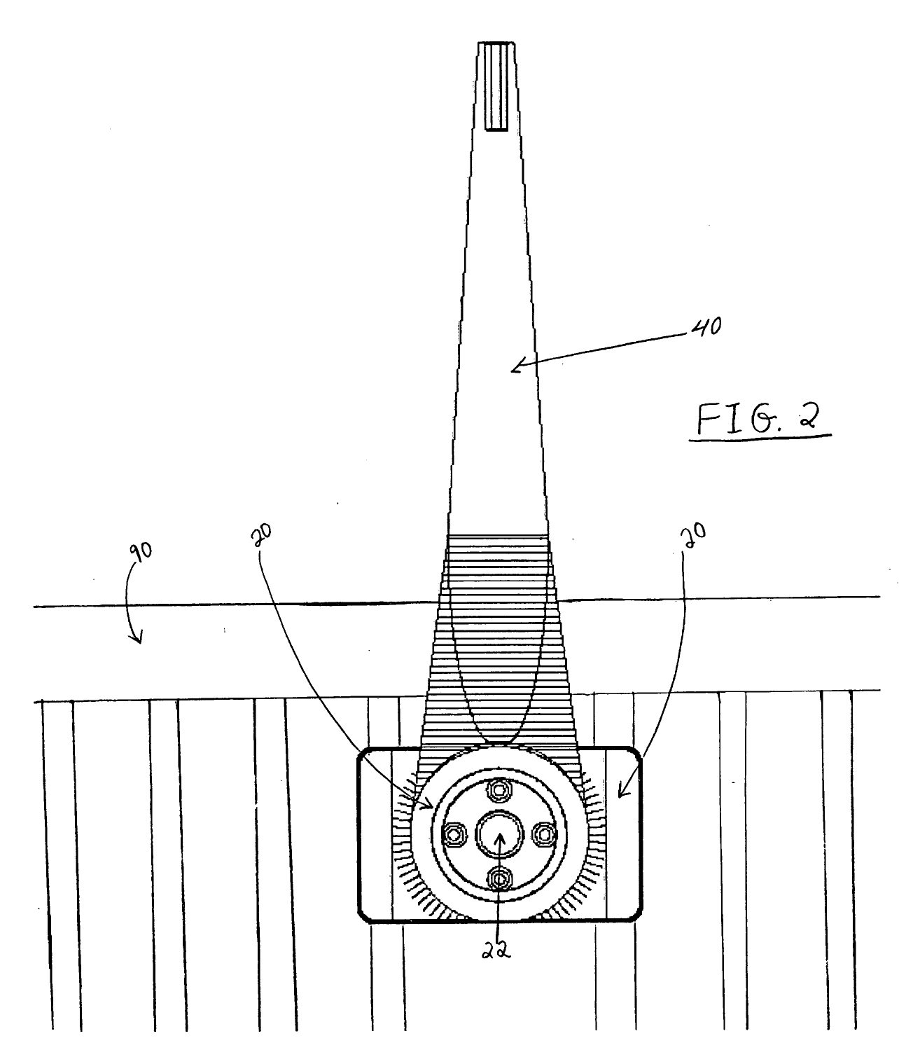

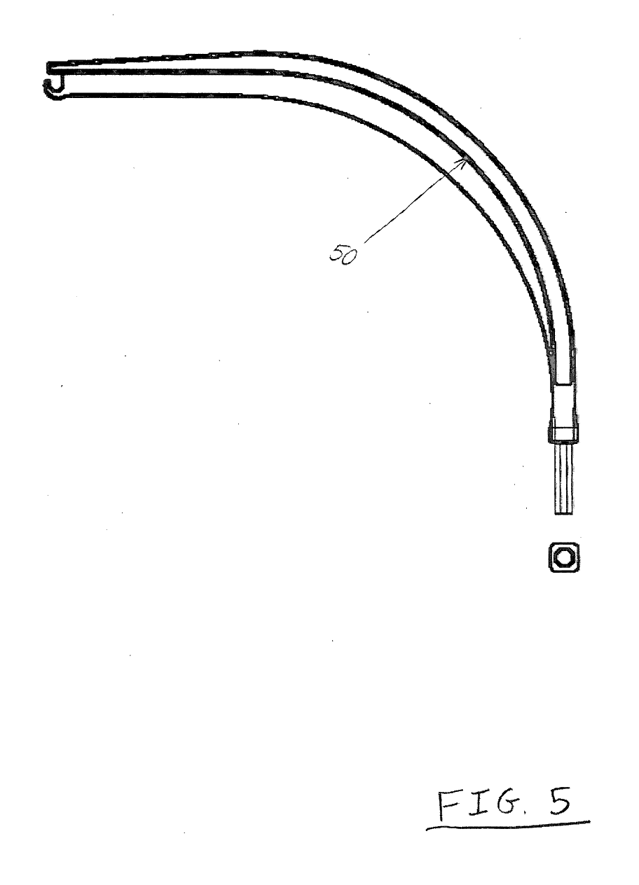

Referring to FIG. 2, part 40 is comprised of a tubular body, or tower, that could be of various height, weight, girth, and other measurements. The function of the tower is to provide the necessary height from which part 50, (as illustrated in FIG. 4 and FIG. 5) the strategically angled rod, attaches. The tower's height can be easily adjusted to meet the needs of any parent or caregiver on a universal array of crib slats by simply changing the position on the slats of the crib upon which the clamp is attached. Therefore, if a parent or caregiver desires to place the mobile at a higher height, the parent or caregiver can attach the clamp on a higher position on the slats. Conversely, if a parent or caregiver desires to place the mobile at a lower height, the parent or caregiver can attach the clamp on a lower position on the slats.

Referring back to FIG. 1, the method of attachment by clamping with a nut and bolt mechanism allows for various tightness levels according to the thickness of a universal array of slats. As with many railings, the sizes and measures of thickness of the railings and slats of a child's crib vary by manufacturer and style. In order to fit a universal array of sizes and measures of slats and railings, the clamping with a nut and bolt mechanism is such that the clamp tightens by manual turning of the bolt and nut. Therefore, a parent or other caregiver installing the crib mobile on a child's crib may set the clamp according to the specific thickness of the slats of the crib upon which they are installing the crib mobile.

Of course, numerous modifications could be made to the above-described embodiments without departing from the scope of the invention, as apparent to a person skilled in the art.

1. A model and method for attaching an object to the slats or spindles of a railing or balustrade, comprising:
a clamp configured for attaching to the slats or spindles of a railing or balustrade by a shaft that passes in the empty space between the slats or spindles;
a pair of jam plates which the clamp tightens or loosens that are covered by a rubber or other non-slip, non-skid, non-abrasive material;
a tubular body of varying possible dimensions and weight elongated along a vertical axis, extending from the top of the clamp mechanism; and
a strategically angled and/or curved rod-like member extending from the top of the tubular body from which an item may be hung.

2. The clamp of claim 1, wherein a nut-and-bolt system runs via a central threaded hole through the shaft of the clamp.

3. The nut-and-bolt system of claim 2, wherein a bolt is threaded into a nut that allows tightening and loosening of the clamp from the slats or spindles.

4. The nut-and-bolt system of claim 3, wherein a locking mechanism prevents the clamp from loosening after it has been tightened to any desired tightness.

5. The nut-and-bolt system of claim 4, wherein a washer with central cores comprises three different sizes for a main bolt, small nut, and large nut.

6. The clamp of claim 1, wherein the jam plates are covered by a non-abrasive, non-skid, and non-slip material such as rubber, by any means, whether before, during, and/or after the manufacturing process.

7. The jam plates of claim 6, wherein the dimensions of the jam plates, including but not limited to the length, width, and thickness, are determined by aesthetic, safety, and practical considerations.

8. The jam plates of claim 7, wherein the visible portions of the jam plate may be covered by any paint, material, or other cover such that it is more aesthetically pleasing, safe, and appropriate for use in the context of an infant's crib.

9. The tubular body of claim 1, wherein the material from which the tubular body is constructed and/or by which the tubular body is covered are variable and determined by aesthetics, safety, and practicability.

10. The angled rod-like member of claim 1, wherein the strategic angle, construction material, and other dimensions may be determined by those dimensions that provide the most weight-bearing capacity.
